(19) United States
(12) Patent Application Publication
(10) Pub. No.: US 2014/0217074 A1
(43) Pub. Date: Aug. 7, 2014

(54) UNDER SURFACE MARKING PROCESS FOR A PUBLIC/PRIVATE KEY

(71) Applicant: Gautam Thor, San Diego, CA (US)

(72) Inventor: Gautam Thor, San Diego, CA (US)

(21) Appl. No.: 14/250,249

(22) Filed: Apr. 10, 2014

Related U.S. Application Data
(63) Continuation of application No. PCT/US2011/055752, filed on Oct. 11, 2011.

(51) Int. Cl. G03H 1/04; B23K 26/00

(52) U.S. Cl. CPC G03H 1/04; B23K 26/006
USPC 219/121.69

(57) ABSTRACT

The innovation involves the use of a laser to ablate a calculated microstructure or employ an adaptation of maskless photolithography using a Digital Micromirror Device to serve as a Spatial Light Modulator to embed a covert diffraction screen, holding encrypted information under transparent surfaces of plastics or glass substrates. One method includes the steps of fragmenting the calculated diffraction screen into at least first and second parts that are placed in separate locations. In this method the binary pattern in each of the parts includes information representing a respective portion of the original image and needs to be interrogated simultaneously to provide a meaningful visual output: each part by itself being incapable of generating any meaningful information. The fragmentation method allows a public-private key type of secure system platform.

### CROSS-REFERENCE TO RELATED APPLICATIONS

This application is a continuation of International Application No. PCT/US2011/055752 filed on Oct. 11, 2011 titled “UNDER SURFACE MARKING PROCESS FOR A PUBLIC/PRIVATE KEY”, which is incorporated by reference herein in its entirety.

### BACKGROUND

1. Field of the Invention

This disclosure relates to systems and methods of encoding images using holograms.

2. Description of the Related Art

Holograms have been commonly used as security devices. Light reflected from an object is allowed to interact with another coherent beam and the interference pattern caused by the two wave fronts results in a recording medium carrying phase and amplitude information of the object. When the recording medium is subsequently illuminated by a coherent source of light, the virtual image of the object becomes apparent. Some types of holograms are even visible in coherent light. Approaches relying on the use of covert images and special verification equipment exist but there is a continuing need in the art for secure information verification and reliable transmission that can be cost-effectively mass produced.

The encryption process itself can be traced to its start in the mid-sixties when Lohman and Paris pioneered the processes to mathematically define images and create Computer Generated Holograms which are essentially diffraction screen consisting of numerous diffracting slits uniquely positioned to give an overall effect of selectively “bending” coherent light (Lohman and Paris Appl. 1967 Optics Vol 6. No. 10, Press et al. 1989 Numerical Recipes. The Art of Scientific Computing. Cambridge University Press, Cambridge, Becker & Dallas 1975 Opt. Comm. 15, 50-133, Gonsalves & Proshaska Proc. SPIES. 1988 938,472-76).

In addition to a method and apparatus for placing CGH related info on the surface, U.S. Pat. No. 7,212,323 May 1, 2007 by Thor and Siddiqi Assigned to Coded Imagery, other relevant patents found in USPTO include U.S. Pat. No. 7,009,741 Mar. 7, 2006 By Payne Assigned to: Quinneteg London UK” Computation of Computer Generated Holograms U.S. Pat. No. 6,608,911 Aug. 19, 2003 By Lofgren N et al Assigned to: Digimarc Corporation Tualatin, Oregon “Digitally watermarking holograms for use with smart card” U.S. Pat. No. 6,527,173 A1 Mar. 23, 2003 By Narusawa et al Assigned to: Victor Company of Japan Ltd, kanagawa-ken Japan “System of issuing card and system of certifying the card” U.S. Pat. No. 6,263,104 Jul. 17 2001 By Stephen McGrew “Method and Apparatus for Reading and Verifying Holograms” U.S. Pat. No. 5,729,365 Mar. 17, 1998. By William C Sweatt Assigned to: Sandia corporation, Albuquerque, New Mexico “Computer Generated Holographic Microtags” U.S. Pat. No. 5,546,198 Aug. 13, 1996 By Joseph van der Gracht and Ravindra Athale “Generation of selective visual effects” U.S. Pat. No. 5,436,740 Jul. 25, 1995 By Nakagawa et al. Assigned to: Fujitsu Ltd Kanagawa Japan. “Holographic Stereograms” U.S. Pat. No. 5,426,520 By Kakae et al. Jun. 20, 1995 Assigned to: Shoei Printing and AMC Co Osaka Japan “Method of Legitimate Product Identification and Seals and Identification Apparatus” U.S. Pat. No. 5,347,375 Sep. 13, 1994 By Saito et al Assigned to: Kabushiki Kaisha Toshibha Kawasaki Japan “Computer Assisted Holographic Image Formation Technique which determines Interference pattern data used to form the hologram” U.S. Pat. No. 5,386,378 Oct. 28, 1992 By Itoh et al Assigned to: Matsushita Electrical Industrial Co, Osaka, Japan “Optical information processing apparatus and method using computer Generated holograms” U.S. Pat. No. 5,111,445 May 5, 1992 By Demetri Psaltis et al Assigned to: Sony System, Japan “Holographic Information Storage System” U.S. Pat. No. 4,960,311 Oct. 2, 1990 By Gaylord E. Moss and John E. Wreede Assigned to: Hughes aircraft, Los Angeles “Holographic Exposure System for Computer Generated Holograms” U.S. Pat. No. 4,880,286 Nov. 14, 1989 By Charles C. 1 h Assigned to: University of Delaware Newark “Making a Holographic Optical Element Using a Computer Generated Hologram” U.S. Pat. No. 4,111,519 Sep. 5, 1978 By Alva Knox Gillis Assigned to: Harris Corporation, Cleveland Ohio “Recording and Reading Synthetic Holograms.”

### SUMMARY

The present invention is directed to procedures for the preparation of computer generated holographic digital images or optical disc logic that can be reproduced using phase contrast modulation under the surface of a transparent material. More specifically the present invention is directed to a method for mass-producing customized and distinctive Computer Generated Holograms (CGH)s of data/images using a 3 dimensional microstructure in the form of a specialized and unique structure. This creates a virtually blank, transparent and featureless object, defying attempts at photography, copying/scanning/reconstruction for unauthorized production of imitation products/documents. Several megabits of information require millions of individualized, sub micron resolution feature sized structures need to be rapidly and reliably created and be produced by systems that have industrial and mass scale capability. It is, therefore, an object of the present invention to improve methods of commercial manufacturing holograms and CGHs. An aspect of the present invention is directed to making mass-manufacturing methods as an improvement over currently available reprographic printing and photographic reproduction methods by using laser ablation under the surface of plastic or glass.

It is, also, an object of the present invention to provide processes, methodologies, and devices that will take complementary subsets of an original information file, encrypt these subsets, and locate them in physically distinct regions enabling the necessity of simultaneous viewing of all subsets, appropriately decoded to generate the complete original image for authentication/verification.

It is still a further object of the present invention to utilize audio files to create binary acoustic holograms to represent yet another aspect of generating encrypted messages from the requisite complementary subsets of the original image.

Still another object of the present invention is to utilize the device(s) that integrate all the required subsets of complementary information, and synthesize the final output as a combination of all decoded messages.

It is still a further object of this invention that files obtained from any part of the electromagnetic spectrum (including the non visible range), in conjunction with a suitable detection device can be used to generate the files necessary for encryption.

And yet still a further object of the present invention is to utilize the design of an appropriate micro-chip (integrated circuit) along with requisite hardware and software to perform the inverse correlative algorithms to encrypt and/or decode or generate a digital reconstruction of the starting image.

### BRIEF DESCRIPTION OF THE DRAWINGS

FIG. 1 illustrates a bump (pit) that causes a one half wavelength path difference relative to surrounding land. (From the Compact Disc Handbook from Pohlman, pg 56, FIG. 3.5.)

FIG. 2 illustrates DMD based lithography on photo-resist will be adapted to enable the reflected light to pass through a micro lenselet array as shown on the right hand side panel.

FIG. 3 illustrates alignment of information placed in 2 different physical locations to produce appropriate original image.

### DETAILED DESCRIPTION

This invention relates in general to digitized electronic signal encoding systems and related image regeneration and, in particular, to holographic image regeneration derived from a mathematically defined digital source images such as Computer Generated Holograms by placing representative 3D (three-dimensional) microstructures that are capable of creating desired interference pattern under the surface of transparent or reflective substrates using either Laser Ablation or modified lithographic processes.

More specifically, but without restriction to the particular embodiments hereinafter described in accordance with the best mode of practice, this invention relates to methods for commercial production of three-dimensional microstructures, placed under the surface of the substrate, but capable of diffracting light under appropriate interrogation to create the starting image. The substrate material may include various types of plastic, glass, chemical coatings (e.g. optically-clear adhesive coatings) or any other suitable transparent or semi-transparent rigid or semi-rigid substrate.

An optically formed hologram is made by recording a complicated fringe pattern made by a interfering a reference beam (often a plane wave) and a beam that has been bounced off the subject object. After the hologram has been properly developed, the net result is a mask with the appropriate absorption and phase delays across the hologram. Computer generated holography uses a computer to calculate the interference of the reference beam with an object beam. Computer-generated holograms (CGHs) are diffractive optical elements synthesized with the aid of computers. CGHs use diffraction to create wavefronts of light with desired amplitudes and phases. A CGH can be a binary hologram, which consists of patterns of curved lines drawn onto or etched into glass substrates. The patterns in a binary CGH may be interpreted as bright and dark interference fringes. A binary CGH can store both the amplitude and phase information of the complex wavefronts by controlling positions, widths, and groove depths of the recorded patterns.

The simplest form of a hologram is a linear diffraction grating, where the spatial frequency of the grating pattern is constant over the entire hologram. A CGH with variable fringe spacing may be viewed as a collection of linear gratings with variable spatial frequencies. The encryption process itself can be traced to its pioneering start in the mid sixties when Lohman and Paris 1967 [Appl Optics, vol 6, issue 10, pgs 1739-1748]. They demonstrated a procedure for creating holograms from objects that could be defined in mathematical terms. A Computer Generated Hologram CGH can be understood as a diffraction screen consisting of numerous diffracting slits uniquely placed to give an overall effect of selectively “bending” coherent light, originating from infinity in such a manner that multiple order beams can be traced back to reinforce a virtual image. Subsequently digital data storage in the form of Fourier transform holograms and the use of optical means to decode such has been used in several situations.

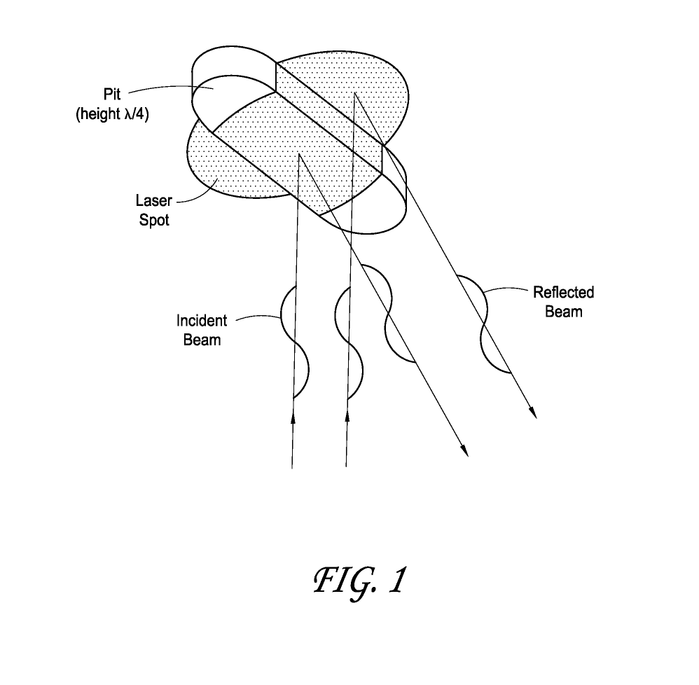

We have further innovated the idea of customized CGHs by generating a 3D microstructure that serves the purpose of binary phase generation that we have called SCIM (Signature Coded Imagery Microstructure). The steps involving the preparation of covert marked patterns (SCIMs) can be understood by analyzing an analogous procedures used in the Optical Disc manufacturing industry, namely in the phase contrast modulated “pits” that are created on a CD to cause diffraction to take place and be read in the CD player. Light diffracted by the grating consists of a zero order and multiplefirst, second order beams that overlap to create destructive and constructive interference patterns (Phase Contrast Modulation) as shown in FIG. 1 for one pit.

The required depth of each pixel unit is a function of the wavelength of light being used and the refractive index of the substrate it passes through. Assuming that a red laser of 650 nm wavelength (λ) is to pass through plastic of Refractive Index ρ=1.55, its effective wavelength in plastic can be calculated as λ effective=ρ. The most effective phase contrast modulation occurs if light is π/2 or 90 degrees out of phase as the crest of one wave would then interact with the trough of a neighboring wave to effectively neutralize the signal. In our case, rays of will pass through the microstructures and interact with each other as they emerge out of the surface. Thus the optimal depth would be ½ the effective wavelength for optimal destructive phase interference.

We have extended this concept of phase contrast modulation to embody multiple “pit” like structures to effectively generate the required microstructure that can be seen as an effective “diffraction screen”, such that, upon illumination by a broad enough beam of light passing through all or most of the structure—simultaneously—produces the overall interference patterned diffractive effect and can generate the required reconstructed image.

Laser Ablation involves the removal of a small amount of material by direct vaporization, i.e. conversion from the Solid State directly to the Vapor State by focusing a burst of Laser Energy over a small area, for an extremely short duration, typically measured in nanoseconds. We have identified laser ablation as a potential methodology that can be adapted to perform the covert embedding in plastic because laser-based tools provide fabrication alternatives that are particularly valuable both, in high-volume industrial production and on a smaller scale. Lasers are now used in the fabrication of stents, catheters and crucial medical device parts. They are also used to mark device components, allowing even the smallest unit to be traced. From a commercial viewpoint we have selected lasers that will have a high repetition rate to ensure faster processing and acceptable pulse and energy parameters for sufficient material removal rate per pulse. The inherent advantage of this process is that although the peak power and energy input directed at the work-piece are very high, the extremely short duration of each pulse minimizes any deformation/cracks or other negative effects on the workpiece in the Heat Affected Zone (HAZ).

Laser pulses can vary over a very wide range of duration (milliseconds to femtoseconds) and fluxes, and can be precisely controlled. This makes laser ablation very valuable for both research and industrial applications. Very short laser pulses remove material so quickly that the surrounding material absorbs very little heat, so laser drilling can be done on delicate or heat-sensitive materials, including tooth enamel (laser dentistry). The ability to concentrate energy fluxes by the passage of the laser light through a convex lens can be used to ablate sub surface as is done in the case of the well established LASIK procedure for correcting vision. In linearly absorbing materials, collateral damage can be largely avoided. Moreover, femtosecond optical pulses in the linear transmission band of a material can be used to modify materials in sub-surface regions.

Sub-surface laser engraving is the process of engraving an image below the surface of a solid material by Laser ablation is a process of removing material from a solid (or occasionally liquid) surface by irradiating it with a laser beam. At low laser flux, the material is heated by the absorbed laser energy and evaporates or sublimates. At high laser flux, the material is typically converted to plasma. The depth over which the laser energy is absorbed, and thus the amount of material removed by a single laser pulse, depends on the material's optical properties and the laser wavelength.

### Sub Surface Marking by Ablation/Galvanometer Beam Steering & Accousto-Optic Q-Switching:

We have identified and established laser ablation as a potential methodology that can perform the covert embedding in plastic or glass. Femto second laser ablation based systems were able to perform the covert embedding on plastic surfaces in trial run using appropriate interfacing technologies by coupling a Acousto-Optic QSwitching system with short pulse widths and very high peak power from a Nd:YAG laser and laser ablating desired microstructures.

Adapting Digital Micro Mirrors As Spatial Light Modulators To Laser Ablate Glass with an Excimer Laser:

The requirement to “individually” ablate each required pixel as proposed above can be circumvented by a hybrid process of using a DMD based reflective surface that acts as a Spatial Light Modulator and an appropriate microlenselet (that focuses the light through a convex surface) in conjunction with an excimer laser. Once the binary information is displayed on the DMD array an ultra-violet light source, or appropriately matched laser that can interact optimally with photoresist can be used by employing maskless photo lithographic procedures. We have used the DMD SLM, configured electronically to be illuminated by an Argon laser of wavelength 426 nm and allow it to be guided by a demagnifier (a focusing optic system) onto positive photo-resist to provide a surface rendition of the desired pattern—that can be transferred to behave as a microstructure by allowing the passage of the SLM reflected “patterned” beam to pass through a micro lenselet (a series of convex lenses in a grid).

Every Digital Light Processing (DLP) based projection system is based on an optical semiconductor known as the Digital Micro-Mirror Device, or DMD chip, which is a MEMS device that was invented by Dr. Larry Hornbeck of Texas Instruments in 1987. The DMD technology has swept the marketplace in movie theaters, home entertainment systems, and professional projectors. In the field of optical telecommunication, this technology has been adapted to act as a Spatial Light Modulator (SLM) in fiber optic lines, essentially acting as wavelength-selectable switches.

The DMD chip is a RAM that is probably the world's most sophisticated light switch containing a rectangular array of up to 1.3 million hinge-mounted microscopic mirrors. These tiny mirrors tilt in response to varying electrical charges on the mirror's mounting substrate. Each of the micro-mirrors can be digitally controlled so in effect the DMD can be considered to be a SLM since it consists of an array of optical elements or pixels, in which each pixel acts independently as an optical valve to adjust or modulate light intensity.

We have established that not only does such a process mark the surface of substrates appropriately—but that interrogation of the DMD chip itself, displaying relevant patterns, when appropriately interrogated with a point source of light—reconstructs the required image—indicating its potential utility as an electronic controlled surface capable of providing required binary information patterns to provide required images.

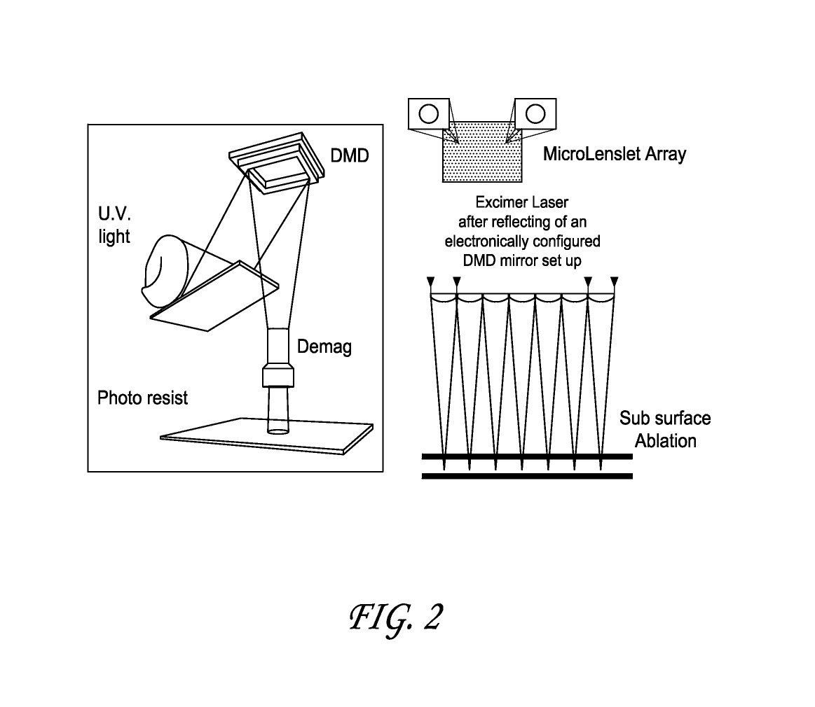

Typical excimer lasers emit pulses with a repetition rate up to a few kilohertz and average output powers between a few watts and hundreds of watts, which makes them the most powerful laser sources in the ultraviolet region, particularly for wavelengths below 300 -400 nm. Their power efficiency varies between 0.2% and 2%. In the case of the new adaptation that we are proposing—we will use a 100 W powered excimer laser—that will bounce off the laser light over a DMD surface. As an extension of this approach, we will replace the “Demagnifyer” with a specialized micro lenslet array that consists of multiple micron sized convex lenses that can focus the laser light into 10 micron, and smaller discs of light—which will be focused into the glass surface to create their ablation as shown on the RHS of FIG. 2.

Lenselets can be as small as 15 microns diameter and using standard materials such as fused silica and silicon and newer materials such as Gallium Phosphide and Calcium Fluoride a wide variety of lenses can be made. Surface roughness values of 20 to 80 angstroms RMS are typical and the addition of AR coatings produces optics with very high transmission rates. Note that the Aluminized mirrors in the DMD are chosen for their high reflectivity and we will select a laser that will not interfere with aluminum.

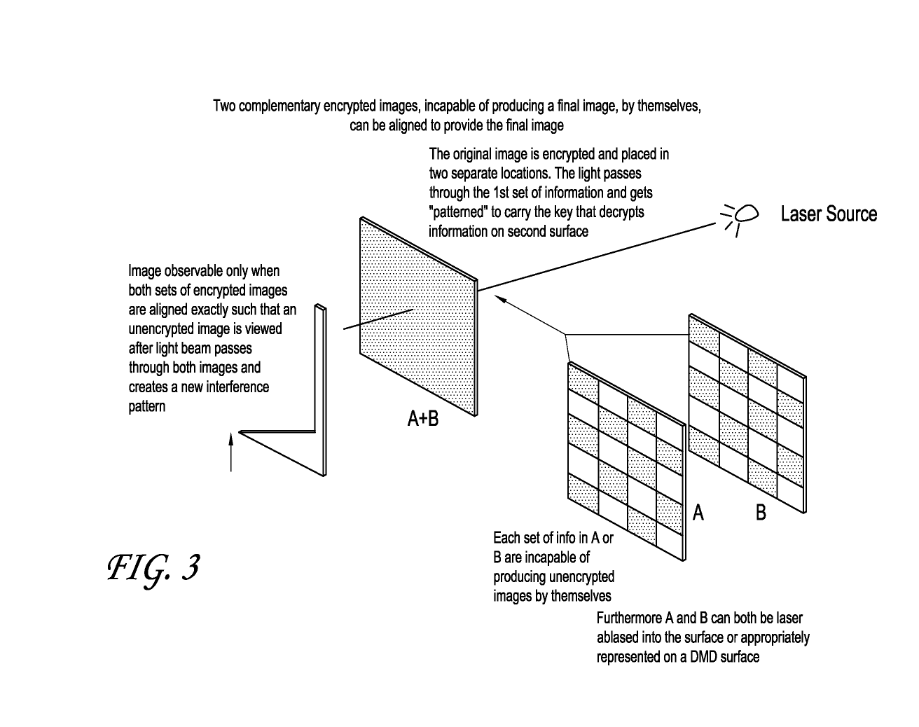

Shown in FIG. 3 is a perspective schematic representation of an arrangement that aligns complementary sets of encrypted information originating from the same source to thereby regenerating the complete original image.

The marks of each image can either be physically placed as appropriately calculated 3 dimensional microstructures or a patterned DMD surface electronically controlled to display a pre calculated pattern.

With reference now to FIG. 3, there is shown a perspective schematic representation of an arrangement that aligns complementary sets of encrypted information originating from the same source to thereby regenerate the complete original image. In this embodiment, the two matrices, A and B, are simultaneously illuminated as only an overall composite matrix is obligatory to be illuminated to reconstruct the complete image. In a preferred embodiment of this particular method, each of the two matrices includes partial and complementary information (fragmented). In this way, only the composite matrix, has to be illuminated to reconstruct the image. It is also possible to place partial information as a sub surface mark and provide the required complementary information electronically through a DMD surface such that only simultaneous interrogation of both surfaces provides relevant information. This enables sub surface information (eg in a biometric ID card) to be placed in the public domain and a private key assisted electronic controlled DMD surface pattern to provide the final image.

While this invention has been described in detail with reference to certain preferred embodiments, it should be appreciated that the present invention is not limited to those precise embodiments. Rather, in view of the present disclosure, which describes the current best mode of practicing the invention, many modifications and variations would present themselves to those skilled in the art, without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. A method of placing a three dimensional, unique, pre calculated diffractive mark below (sub surface) a desired transparent or reflective substrate such that upon appropriate interrogation using a point source of light, through the mark, the original image is made visible;

2. A method of placing a three dimensional, unique, pre calculated diffractive mark below (sub surface) a desired transparent or reflective substrate using laser ablation, such that upon appropriate interrogation using a point source of light, through the mark, the original image is made visible;

3. A method of placing a three dimensional, unique, pre calculated diffractive mark below (sub surface) a desired transparent or reflective substrate using a Digital Micromirror Device (DMD) type reflective surface in conjunction with a grid of convex lenses (lenselets) that focus several laser beams simultaneously and ablate the desired substrate such as a transparent or reflective surface such that upon interrogation with an appropriate point source of light, through the mark, the original image is made visible;

4. A method of placing a three dimensional, unique, pre calculated diffractive mark below (sub surface) a desired transparent or reflective substrate comprising of providing a substrate for supporting recorded image information in a binary form; providing a first binary pattern containing partial information of a first original image; providing a second binary pattern containing the remaining (complementary) information of a second original image, said first and a second binary patterns arranged as marks on said substrates in two different locations, in a desired manner to thereby create a recording of an integrated image including said first and second original images, such that upon interrogation with an appropriate point source of light, through the mark, the original image is made visible, and

5. A method of placing a three dimensional, unique, pre calculated diffractive mark below (sub surface) a desired transparent or reflective substrate; comprising of providing a substrate for supporting recorded image information in a binary form; providing a first binary pattern containing partial information of a first original image as a pre determined diffractive mark; providing a second binary pattern containing the remaining (complementary) information of a second original image in the form of an electronic rendition such as the appropriate patterned DMD or similar surface, said first and second binary patterns; arranged in a desired manner to thereby create a recording of an integrated image including said first and second images; and illuminating both simultaneously such that upon interrogation with an appropriate point source of light, through the mark, the original image is made visible
